(19) United States
(12) Patent Application Publication
(10) Pub. No.: US 2018/0140140 A1
(43) Pub. Date: May 24, 2018

(54) MODULAR UTENSIL FOR HANDLING FROZEN FOOD ITEMS

(71) Applicant: REBECCA WILSON, KISSIMMEE, FL (US)

(72) Inventor: REBECCA WILSON, KISSIMMEE, FL (US)

(21) Appl. No.: 15/356,353

(22) Filed: Nov. 18, 2016

(51) Int. Cl. A47J 43/28; A47J 9/00; B26B 11/00

(52) U.S. Cl. CPC A47J 43/282; B26B 11/008; A47J 9/003

(57) ABSTRACT

A modular utensil for handling frozen and semi-frozen food items is disclosed. The modular utensil includes a replaceable utensil portion having an anterior part and a posterior part and a handle portion detachably connected to the utensil portion. The anterior part is configured to collect and transfer the frozen food items and the posterior part extends from the anterior part forming an arm of the utensil portion. The handle portion further includes a heating means and a power supply means. A user can activate a control button provided on the handle portion to enable power supply from the power supply means to the heating means, which in turn heats the heating means and the utensil portion enabling localized melting of the frozen food item at a surface of contact of the frozen food item and the anterior part of the utensil portion leading to easy transferring of the frozen food item.

### BACKGROUND OF THE EMBODIMENT

### Technical Field of the Embodiment

The present embodiment relates to a modular utensil for collecting and easily transferring frozen and semi-frozen food items. More specifically, the present embodiment relates to an electrically heated modular utensil in form of an ice cream scoop for scooping and easily serving the ice cream.

### DESCRIPTION OF THE RELATED ART

Frozen or semi frozen food items such as ice creams and desserts are stored in a cold container. The food items stored in the cold containers are often hard and it is difficult for a person to remove the frozen or semi frozen food items such as ice creams and desserts from the cold container. The bulk of the frozen or semi frozen food items such as ice creams and desserts stored in the cold containers are dipped with conventional ice-cream scoops and the person holding the ice-cream scoop apply a considerable amount of force for scooping the ice cream using the conventional ice-cream scoop. Moreover the conventional ice cream scoops are made from steel and the temperature of it lowers as soon as it touches the frozen or semi frozen food item stored in the cold container. As the temperature of the scoop lowers, the ice cream collected on it freezes therein and sticks to the surface of the scoop. In some scoops, mechanical scraping blades are provided to discharge the ice cream from the scoop, but they also freeze and become difficult to operate and, at times, they break, defeating the purpose of such attachments.

Some other prior arts disclose the use of heated ice cream scoops having one or more heating elements which increases the temperature of the ice cream scoop to easily transfer the frozen or semi-frozen ice cream collected on the scoop. These heated ice cream scoops utilize heating fluids such as oil, liquid wax, mercury and the like, within the scoop, which prevents freezing of the frozen or semi-frozen ice cream on to the surface of the ice cream scoop. However these heated ice cream scoops are not reliable and unsatisfactory to operate because there is a chance of leakage of the fluids caused by the continuous usage, which wears out the seals thereby causing contamination of the ice cream. In some prior arts, mercury is used as the heat-sustaining element, however it is dangerous if it leaks out and mixes with ice cream.

Various heated ice cream scoops are available in the market, however none of them overcomes the above stated issues. Of particular note, the following patents are herein incorporated by reference for their supportive teachings, in which:

U.S. Pat. No. 4,553,921 A issued to Carla on Nov. 19, 1985, which discloses an electrical ice cream dipper that consists of a handle portion having a finger grip area, a scoop portion having a semi-spherical bowl affixed to the handle portion, a means for heating the scoop portion, a means for controlling the temperature in the scoop portion and a stand having a pair of folding legs built into the handle portion so that the scoop portion will be supported when not in use. However the electrical ice cream dipper has the heating coil provided in the scoop portion and the handle portion with the electrical controlling means may get damaged while cleaning or washing the ice cream scoop.

U.S. Pat. No. 6,416,309 B1 filed by Kenneth et al. on Feb. 18, 1999 discloses a method and apparatus for serving ice cream with a chemically-heated ice cream scoop. The scoop comprises a bowl and a handle with an interior cavity filled with a nontoxic, super-coolable salt solution. Triggering an activator in fluid communication with the solution may selectively crystallize the salt solution. Crystallization evolves a significant amount of heat that is used to elevate the temperature of the scoop bowl, thereby decreasing the cutting force required to separate a serving of ice cream from a storage container and reducing adherence of the ice cream within the scoop bowl. After use, elevating the temperature of the crystallized solution above its crystallization temperature may recharge the scoop. The process of crystallization, melting, and super-cooling may be repeated indefinitely. However the above cited prior art suffers from the above-discussed disadvantages.

Another patent U.S. Pat. App. No. 20030113396 discloses an ice cream scoop that optimizes the total heat capacity of the scoop by increasing the mass of the ice cream scoop and/or increasing the amount of liquid the ice cream scoop. The ice cream scoop also allows for two methods of increasing the heat transfer from the heat source to the scoop portion. The first version utilizes a heat pipe that directs the heat flow directly to the location requiring the heat. The second version utilizes a highly conductive material that has a higher rate of conductivity than that of aluminum. However the above configuration has the following disadvantage that the continuous usage, cleaning and washing of the ice cream scoop causes the heating coil to get damaged easily.

Hence, it can be seen that there is a need for a modular or detachable utensil for handling frozen food materials. The needed utensil would allow the users to detach the electrical heating part easily before cleaning and washing of the utensil. The needed utensil would be easy to hold and operate and would not harm the users while handling due to the heat generated by the electrical heating part.

### SUMMARY OF THE INVENTION

The present invention is a modular utensil for collecting and easily transferring frozen and semi-frozen food items such as ice cream from a storage container. The modular utensil has a scoop portion and a handle portion that is detachably connected to the scoop portion. The scoop portion of the modular utensil further includes an anterior part for collecting and transferring the frozen or semi-frozen food items such as ice cream and a posterior part that extends from the anterior part forming an arm of the scoop portion. The handle portion is detachably connected to the posterior part of the scoop portion using a mechanical locking arrangement. The handle portion further includes a heating means such as a heating coil to heat the scoop portion to a temperature sufficient enough to slightly melt a surface of contact of the frozen food item collected on the anterior part or the food collecting part of the modular utensil. An electrical power supply means such as rechargeable batteries positioned within the handle portion power the heating means. A user can activate a control button provided on the handle portion to control the power supply from the power supply means to the heating means. The modular utensil further includes a release button that can be manually operated to detach the scoop portion from the handle portion.

A method for using the modular utensil for contacting a frozen or semi-frozen food item such as ice cream or dessert from a container and easily transferring the food item to a different dishware starts with the step of holding the handle portion of the modular utensil by the user and contact the frozen or semi-frozen food item from the container. Once the user contacts the frozen food item using the anterior part or the food collecting part of the utensil portion, he/she can activate the control button on the handle portion to enable power supply to the heating means, which in turn heat the heating means and the anterior part or food collecting part of the utensil portion. The increased temperature at the surface of contact of the frozen or semi-frozen food item collected on the anterior part of the utensil portion slightly melts the frozen or semi-frozen food item. The temperature rise at the anterior part of the utensil portion is such that the frozen or semi-frozen food item is only melted at the surface of contact with the anterior part of the utensil portion. Now the user can easily transfer the frozen or semi-frozen food item to a desired place or dishware. Once the food item is transferred, the user can deactivate the control button on the handle portion to stop power supply to the heating means. Moreover, the user can detach the utensil portion from the handle portion by manually operating the release button provided on the handle portion, which releases the mechanical locking arrangement connecting the utensil portion and the handle portion. Whereby, a different utensil portion may be therein attached, like another ice cream scoop or a butter knife, both of which are designed with heating elements therein.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a perspective view of the present modular utensil designed for handling a variety of frozen food items, according to a preferred embodiment of the present disclosure; and

FIG. 2 is a flowchart showing a number of steps for collecting and transferring frozen or semi-frozen food items from storage containers using the present modular utensil, according to a preferred embodiment of the present invention;

FIG. 3 is a perspective view of one embodiment where the handle is separatable from the scoop.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

The present disclosure relates to a modular utensil for handling a variety of frozen food items such as, but not limited to, different types of ice creams, chocolates, frozen or semi-frozen desserts and other frozen food items. The frozen food items are generally stored in cold containers and are in a solid form inside the container. Oftentimes it is difficult for the users to collect and serve a desired quantity of the stored frozen food items in solid state using existing utensils such as, but not limited to, ice cream scoops, a Disher style scoop or transfer scoops. The user has to put a lot of effort to collect the frozen food item from the cold container and once the frozen food item is collected, it gets stick to the utensil making it is difficult to serve. The present modular utensil is developed to easily collect and serve the frozen food item. The present modular utensil is provided with an electrical heating means that is capable of heating the frozen food collecting part of the utensil, which in turn melts the frozen food item at a surface of contact of the frozen food item and the frozen food collecting part of the utensil enabling easy transfer of the frozen food item.

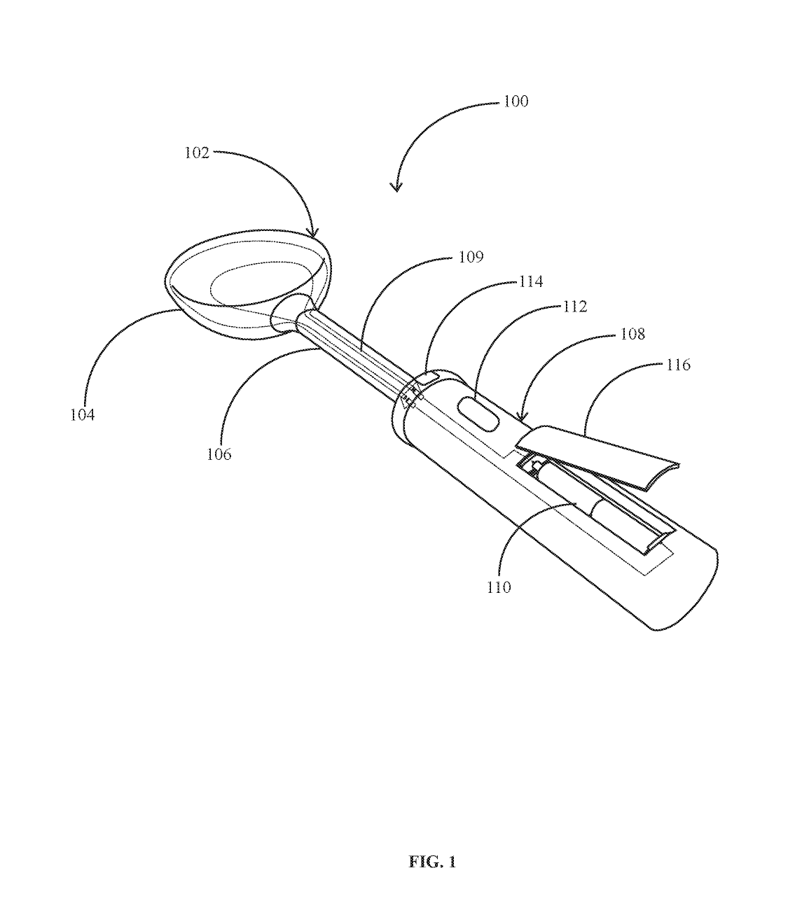

FIG. 1 illustrates a perspective view of the present modular utensil 100 designed for handling a variety of frozen food items, according to a preferred embodiment of the present disclosure. According to a preferred embodiment, the modular utensil 100 is an ice cream scoop having a scoop portion 102 for collecting frozen food items from the cold container. The scoop portion 102 has an anterior part 104 shaped to collect and transfer the frozen food items and a posterior part 106 extending from the anterior part forming an arm 106 of the scoop portion 102. The anterior part 104 of the scoop portion 102 is available in different shapes including a semi-spherical shape to collect and transfer the frozen food item. In some embodiment, the anterior part 104 of the scoop portion 102 has different shapes such as, but not limited to, rectangular, conical shape, shovel shape, etc. The posterior part or arm 106 of the scoop portion 102 extends from the anterior part 104 and has a length sufficient enough for the easy handling of the modular utensil 100 for collecting and serving the frozen food items. The modular utensil 100 further includes a handle portion 108 detachably connected to the posterior part 106 of the scoop portion 102. The handle portion 108 is detachably connected to the arm 106 of the scoop portion 102 using a releasable mechanical device or arrangement (not shown). The releasable mechanical locking arrangement can be designed in dozens of ways that are well known by skilled artisans, and include, but not limited to, an insert and tilt locking arrangement, push button locking means, a blade that swings across its interior surface to dislodge the contents, a levered plate positioned at a bottom of the scoop to push the contents upward and out, etc.

The receiving end of the handle portion 108 includes provisions for receiving and forming a releasable lock with the posterior part or the arm 106 of the scoop portion 102. The handle portion 108 further includes a heating means 109, which is attached to the receiving end of the handle portion. The heating means 109 associated with the handle portion 108 makes contact with the arm 106 of the scoop portion 102, when the modular utensil 100 is in an assembled state, to transfer the heat generated by the heating means 109 to the scoop portion 102. The handle portion 108 further includes provisions for a power supply means 110 that is positioned within a recess provided on the handle portion 108. The power supply means 110 includes one or more rechargeable batteries positioned in the recess. The recess on the handle portion includes electrical connections to receive power from the rechargeable batteries 110 and pass the electrical power to the heating means 109 to increase the temperature of the heating means 109 and the scoop portion 102 to a predetermined level. The electrical power supply from the power supply 110 is controlled using a control button 112 provided on the handle portion 108 of the modular utensil 100. A user can press or switch on or activate the control button 112 provided on the handle portion 108 of the modular utensil 100 to pass electrical current through the heating means 109. This increases the temperature of the heating means 109 and the scoop portion 102 in contact with the heating means 109. The increased temperature of the scoop portion 102 enables localized melting of the frozen food item at a surface of contact of the frozen food item and the anterior part 104 of the scoop portion 102 leading to easy removal of the frozen food item from the modular utensil 100.

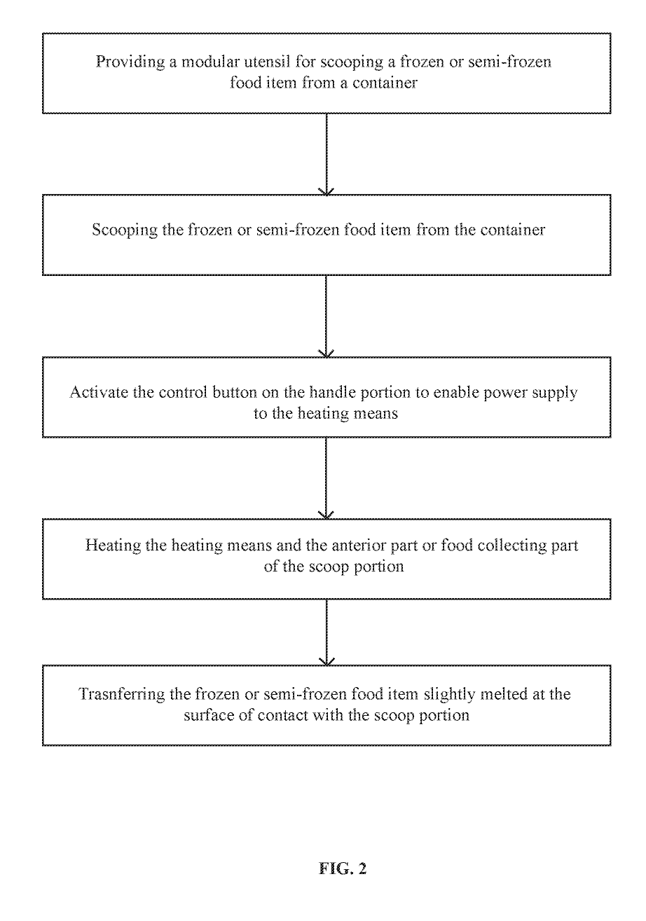

FIG. 2 is a flowchart showing a number of steps for collecting and transferring frozen or semi-frozen food items from storage containers, according to a preferred embodiment of the present invention. The users can first hold the handle portion 108 of the modular utensil 100 to scoop or collect the frozen or semi-frozen food item from the storage container. Once the frozen or semi-frozen food item is collected in the anterior food collecting part 104 of the scoop portion 102, the user can activate the control button 112 provided on the handle portion 108 of the modular utensil 100. This enables the current flow from the rechargeable batteries of the power supply means 110 through the heating means 109 and increases the temperature of the heating means 109 to a desired level. The heating means 109 and the electrical circuitry associated with the power supply means 110 is configured such that the temperature rise in the heating means 109 is within a particular limit so that the user handling the modular utensil 100 not to receive heat burns, any other harm or discomfort while utilizing the modular utensil 100 to scoop or collect the frozen or semi-frozen food item from the storage container. The heat generated by the heating means 109 positioned in the handle portion 108 is transferred to the scoop portion 102 upon activation of the control button 112. This enables the contact surface of the frozen or semi-frozen food item collected in the anterior food collecting part 104 of the scoop portion 102 to melt and thereby enabling easy transferring of the food item without much effort by the user. Once the user transfers the frozen or semi-frozen food item, he/she can deactivate the control button 112 to prevent electric power supply to the heating means 109.

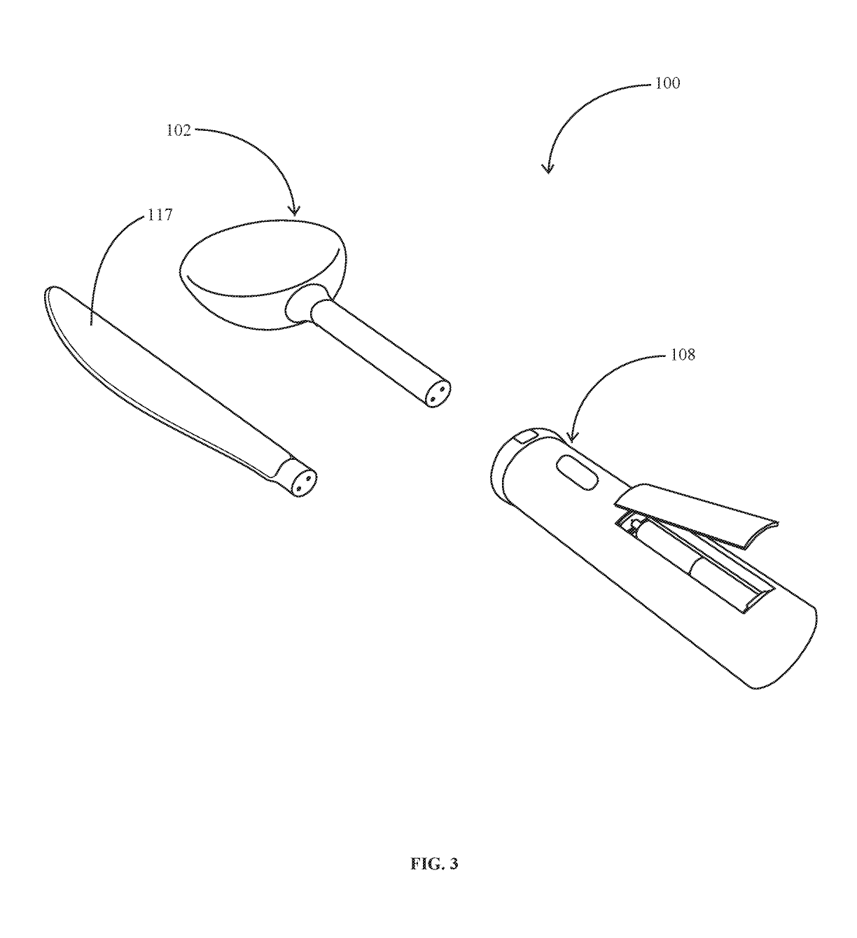

Referring to FIG. 3, in a preferred embodiment of the present disclosure, the handle portion 108 and the scoop portion 102 of the modular utensil 100 is detachable by the user. The handle portion 108 is provided with a release button 114 to allow users to easily detach the scoop portion 102 from the handle portion 108 by simple activation of the release button 114. The release button 114 can be provided as a push button, slide button or any other type for the easy activation and subsequent detachment of the scoop portion 102 from the handle portion 108. The manual activation of the release button 114 releases the mechanical locking arrangement between the arm 106 of the scoop portion 102 and the handle portion 108. The easy detachment of the scoop portion 102 and the handle portion 108 of the modular utensil 100 enables easy cleaning or washing of the scoop portion 102 after use. Additionally, other devices may be added to the heated system, like a knife 117, that may be heated from the heating element 109 imbedded therethrough, to more easily cut through butter that is often too cold and hard for a regular butter knife. The recess on the handle portion for accommodating the rechargeable batteries of the power supply means 110 is covered using a covering means 116 as shown in FIG. 1. The covering means 116 is designed to be in flush with the surface of the handle portion when it is in a closed state. This allows the user to comfortably hold the handle portion 108 while collecting and transferring the frozen food item from the cold container. Further, the handle portion 108 is made from non-conductive materials offering grip and comfort to the user, which makes it easier for the user to handle the modular utensil 100. In some embodiment, the handle portion 108 of the modular utensil 100 is made from plastic and rubber materials, however any kind of material offering grip and comfort to the user can be used for the handle portion 108, and the covering means 116 covering the recess on the handle portion 108 forms a water impermeable seal on the recess. This allows the modular utensil 100 to be used in both dry and wet conditions.

The users can utilize the modular utensil 100 for scooping frozen or semi-frozen food items from the storage containers and for easily transferring the frozen or semi-frozen food item collected in the anterior part 104 of the scoop portion 102 by heating the anterior part 104 of the scoop portion 102 as discussed above.

According to another embodiment of the present modular utensil 100, the increased temperature at the scoop portion 102 of the modular utensil 100 can be utilized for both during collecting or scooping and transferring the frozen or semi-frozen food item from the storage container. The user can first activate the control button 112 to enable electric power supply 110 to the heating means 109. Then the heated anterior food collecting part 104 of the scoop portion 102 can be used to easily scoop or collect the frozen or semi-frozen food item from the storage container, as the surface of contact of the heated anterior food collecting part 104 slightly melts and softens the frozen or semi-frozen food item in the container. Now the collected frozen or semi-frozen food item on the heated anterior food collecting part 104 of the scoop portion 102 can be easily transferred without much difficulty. The user can then deactivate the control button 112 after use.

In some other embodiment of the present modular utensil 100, the handle portion 108 includes an electrical circuitry to limit the current flow to the heating means or the heating coil in contact with the scoop portion 102. The electrical circuitry automatically controls the power supply from the rechargeable battery of the power supply means 110 when the control button 112 is in an ‘ON’ state. This allows the controlled delivery of electrical current through the heating means or the heating coil, which in turn automatically controls the heat generated by the heating means 109 thereby preventing burns or other harms to the user while handling the modular utensil 100.

In a yet another embodiment, the modular utensil 100 has detachable anterior food collecting part 104 of the scoop portion 102, posterior part or arm 106 of the scoop portion 102 and handle portion 108. The anterior part 104 of the scoop portion 102 for collecting the frozen food is detachably connected to the arm or extended posterior part 106 of the scoop portion 102. The posterior part or arm 106 and the anterior part 104 of the scoop portion 102 is connected using a mechanical attachment means such as threaded locking arrangement, or any other releasable mechanical locking arrangement. Further the heating extends from the handle portion 108 through a hollow interior of the posterior part 106 of the scoop portion 102 and makes contact with the anterior part 104 of the scoop portion 102. The heating means 109 passing through the hollow interior of the posterior part 106 of the scoop portion 102 is insulated to prevent the wastage of heat to the arm of the scoop portion 102. This arrangement in turn transfers the heat generated by the heating means 109 directly to the anterior part 104 of the scoop portion 102 for scooping or collecting the frozen or semi-frozen food items such as ice cream from the storage container. In this type modular utensil 100 only the anterior part 104 of the scoop portion 102 is heated up to melt the surface of contact of the frozen or semi-frozen food item and thereby allowing the users to easily transfer the frozen or semi-frozen food item. Moreover, in some other embodiment, the posterior part 106 of the scoop portion 102 is made from a rigid insulating material having a hollow interior connecting to the anterior part 104 of the scoop portion 102 and the handle portion 108 at either ends. This ensures the direct transfer of the heat generated by the heating means 109 to the anterior part 104 of the scoop portion 102 to partially melt and soften the surface of contact of the frozen or semi-frozen food item on the anterior part 104 or the scooping part of the modular utensil 100.

In a yet another embodiment of the present modular utensil 100, the posterior part 106 or arm of the scoop portion 102 continuously extends from the anterior part or frozen food scooping part 104 of the scoop portion 102 and detachably connected to the handle portion 108 of the modular utensil 100. The posterior part or arm 106 of the scoop portion 102 includes a heat transfer arrangement such as a heat transfer coil positioned within a hollow interior, which makes contact with the anterior part or frozen food scooping part 104 of the scoop portion 102 at one end and the heating means 109 provided at the handle portion 108 at the other end. The heat transfer coil positioned within a hollow interior of the posterior part or arm 106 of the scoop portion 102 transfers the heat generated by the heating means 109 provided within the handle portion, upon activation of the control button 112. The heated anterior part or arm 104 of the modular utensil 100 partially melts the surface of contact of the frozen or semi-frozen food item on the anterior part 104 or the scooping part of the modular utensil 100 and the user can easily transfer the frozen or semi-frozen food item such as ice cream.

According to another embodiment of the present disclosure, the modular utensil 100 is an ice cream scoop 100 for collecting and easily transferring frozen or semi-frozen ice cream to desired place by the users. The users can insert rechargeable batteries with in the recess on the handle portion 108 configured to receive the batteries. In some embodiment, the handle portion 108 comes with built-in rechargeable batteries with provisions for charging the batteries after detaching the handle portion 108 from the scoop portion 102 of the modular utensil 100. The modular utensil 100 is an ice cream scoop 100 can be used by the users to collect or scoop the ice cream from the container and then the user can activate or ‘ON’ the control button 112 on the handle portion to melt the surface of contact of the ice cream scoop on the anterior part 104 or the scooping part of the modular utensil 100. The temperature increase in the anterior part 104 or the scooping part of the modular utensil 100 is in real-time or done instantaneously. The temperature of the anterior part 104 or the scooping part of the modular utensil 100 is slightly increased such that the ice cream scoop can be easily detached or transferred from the anterior part 104 or the scooping part of the modular utensil 100.

Several embodiment of the present disclosure include the use of the present modular utensil 100 for other applications such as collection and transfer of other frozen or semi frozen items, not necessarily food products. In all such cases the basic arrangements of the modular utensil 100 and the method of operating the modular utensil 100 remains the same. All such modifications come under the scope of the present disclosure.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, different designs of the anterior part or the scooping part 104 of the scooping portion 102 can be provided and can be detachably connected to the handle portion 108 having electrical heating means 109. Further, different methods and arrangements can be provided for transferring the heat generated by the heating means 109 provided on the handle portion 108 to the anterior part or the scooping part 104. Moreover, the heating means 109 and the electrical circuitry associated with the power supply means 110 can include automatic controls and sensors to enable automated heating of the modular utensil without manual activation of the control button. It is intended that the scope of the present invention not be limited by this detailed description, but by the claims and the equivalents to the claims appended hereto.

We claim:

1. A modular utensil for handling a plurality of frozen food items, comprising:
a utensil portion having an anterior part and a posterior part,
wherein the anterior part is configured to interact with the frozen food items and the posterior part extends from the anterior part forming an arm of the scoop portion;
a handle portion detachably connected to the posterior part of the utensil portion;
at least one heating system associated with the handle portion to heat the utensil portion;
a power supply positioned within the handle portion to power the heating system; and
at least one control button provided on the handle portion to control power supply from the power supply;
whereby activation of the control button by a user heats the heating system and the utensil portion enabling localized melting of the frozen food item at a surface of contact of the frozen food item and the anterior part of the utensil portion leading to easy removal of the frozen food item.

2. The modular utensil of claim 1 wherein the anterior part of the utensil portion is a scoop that is provided with a desired shape including a semi-spherical shape to collect and transfer the frozen food item.

3. The modular utensil of claim 1 wherein the handle portion is detachably connected to the arm of the utensil portion using a releasable mechanical locking arrangement.

4. The modular utensil of claim 1 wherein the handle portion includes a release button to detach the utensil portion from the handle portion.

5. The modular utensil of claim 1 wherein the power supply includes at least one rechargeable battery positioned in a recess having a plurality of electrical connections on the handle portion.

6. The modular utensil of claim 5 wherein the recess on the handle portion is covered using a covering designed to be in flush with a surface of the handle portion in a closed state.

7. The modular utensil of claim 1 wherein the heating system associated with the handle portion is in contact with the arm of the utensil portion to heat the surface of contact of the frozen food item and the anterior part of the scoop portion for easy removal of the frozen food item.

8. The modular utensil of claim 1 wherein activation of the control button enables power supply from the power supply to the heating system and heats the scoop portion to a low temperature sufficient to remove the frozen food item from the anterior part of the utensil portion.

9. The modular utensil of claim 1 wherein the handle portion is made from non-conductive materials offering grip and comfort to the user.

10. The modular utensil of claim 1 wherein the utensil portion is a butter knife that is heated before being used to cut into cold butter.
